(19) United States
(12) Patent Application Publication
(10) Pub. No.: US 2026/0270518 A1
(43) Pub. Date: Sep. 10, 2026

(54) VIDEO PLAYBACK METHOD, VIDEO PLAYBACK TERMINAL, CONTROL TERMINAL, AND VIDEO PLAYBACK SYSTEM

(71) Applicant: ARASHI VISION INC., Shenzhen (CN)

(72) Inventors: Chunhong DENG, Shenzhen (CN); Yongjie HUANG, Shenzhen (CN)

(73) Assignee: ARASHI VISION INC., Shenzhen (CN)

(21) Appl. No.: 19/466,511

(22) Filed: Feb. 2, 2026

Related U.S. Application Data
(63) Continuation of application No. PCT/CN2024/101904, filed on Jun. 27, 2024.

(51) Int. Cl. H04N 21/472; H04N 21/431

(52) U.S. Cl. CPC H04N 21/47217; H04N 21/4316

(57) ABSTRACT

In some aspects, the present disclosure provides a video playback method implemented on a video playback terminal. A flight trajectory map can be displayed on a video playback screen during a playback process of a target video. The flight trajectory map may include a flight trajectory, and the flight trajectory comprises at least one first highlight mark configured to locate one or more highlight segments in the target video.

### CROSS-REFERENCE TO RELATED APPLICATION

This application is a continuation of International Application No. PCT/CN2024/101904, filed on June 27, 2024, the entire content of which is hereby incorporated by reference in its entirety.

### BACKGROUND

The present disclosure relates to, but is not limited to, a video playback method, a video playback terminal, a control terminal, and a video playback system.

With the development of aircraft technology, users can perform aerial photography by operating an aircraft to shoot videos from a unique perspective. However, during the playback of videos obtained by aerial photography, since there are few reference objects in the video, the displayed frames are basically similar, making it difficult for users to locate highlight segments in the video.

### SUMMARY

The following is an overview of the subject matter described in detail in the present disclosure. This overview is not intended to limit the scope of protection of the claims.

The present disclosure provides a video playback method, a video playback terminal, a control terminal, and a video playback system.

A first aspect of the present disclosure provides a video playback method, implemented on a video playback terminal, and the video playback method includes:

displaying a flight trajectory map on a video playback screen during a playback process of a target video, where the flight trajectory map includes a flight trajectory, and the flight trajectory includes at least one first highlight mark configured to locate one or more highlight segments in the target video.

A second aspect of the present disclosure provides a video playback terminal. The video playback terminal includes a memory and a processor. The memory is configured to store program instructions, and when the program instructions are executed by the processor, the processor is configured to:

display a flight trajectory map on a video playback screen during a playback process of a target video, where the flight trajectory map includes a flight trajectory, the flight trajectory includes at least one first highlight mark configured to locate one or more highlight segments in the target video.

A third aspect of the present disclosure provides a control terminal. The control terminal is connected to the video playback terminal as described in the second aspect.

A fourth aspect of the present disclosure provides a video playback system, the video playback system includes a video playback terminal and a control terminal, and the control terminal is connected to the video playback terminal.

The control terminal is configured to, in response to a playback operation, send a first playback control signal to the video playback terminal.

The video playback terminal is configured to play a target video based on the received first playback control signal and display a flight trajectory map on a video playback screen.

The flight trajectory map includes a flight trajectory, the flight trajectory includes at least one first highlight mark configured to locate one or more highlight segments in the target video.

In the video playback method, video playback terminal, control terminal, and video playback system provided in the implementations of the present disclosure, during the playback of a target video shot by an aircraft, a flight trajectory map is displayed on the video playback screen to show the shooting position of the target video. The first highlight mark is displayed in the flight trajectory of the flight trajectory map, and the first highlight mark is configured to locate one or more highlight segments in the target video, so that the user can locate the highlight segment to be watched through the flight trajectory and the first highlight mark. Since the user can locate the highlight segment through the first highlight mark in the flight trajectory map during the process of playing the target video, the efficiency of locating highlight segments is improved. At the same time, since the flight trajectory corresponds to the shooting position of the target video, the flight trajectory can also be configured as a progress bar for playing the target video, thereby reducing the complexity of video positioning.

Other aspects can be understood after reading and understanding the drawings and detailed description.

### BRIEF DESCRIPTION OF DRAWINGS

The drawings incorporated into the specification and constituting part of the specification show the implementations of the present disclosure and, together with the description, are used to explain the principles of the implementations of the present disclosure. In these drawings, similar reference numerals are used to indicate similar elements. The drawings described below are some implementations of the present disclosure, but not all implementations. For those skilled in the art, other drawings can be obtained based on these drawings without creative work.

FIG. 1 is a flowchart of a video playback method, according to an exemplary implementation of the present disclosure.

FIG. 2 is a schematic diagram of a video playback screen, according to an exemplary implementation of the present disclosure.

FIG. 3 is a schematic diagram of a video playback screen, according to another exemplary implementation of the present disclosure.

FIG. 4-1 is a schematic diagram of a flight trajectory map, according to an exemplary implementation of the present disclosure.

FIG. 4-2 is a schematic diagram of a flight trajectory map, according to another exemplary implementation of the present disclosure.

FIG. 5 is a schematic diagram of a video playback screen, according to another exemplary implementation of the present disclosure.

FIG. 6 is a schematic diagram of a video playback screen, according to another exemplary implementation of the present disclosure.

FIG. 7-1 is a schematic diagram of a video playback screen, according to another exemplary implementation of the present disclosure.

FIG. 7-2 is a schematic diagram of a video playback screen, according to another exemplary implementation of the present disclosure.

FIG. 8 is a schematic diagram of a video playback screen, according to another exemplary implementation of the present disclosure.

FIG. 9 is a flowchart of a video playback method, according to another exemplary implementation of the present disclosure.

FIG. 10 is a block diagram of a computer device, according to an exemplary implementation of the present disclosure.

### DETAILED DESCRIPTION

The following will describe the technical solutions in the implementations of the present disclosure clearly and completely in conjunction with the drawings in the implementations of the present disclosure. Obviously, the implementations described are part of the implementations of the present disclosure, but not all of the implementations. Based on the implementations in the present disclosure, all other implementations obtained by those skilled in the art without creative work are within the scope of protection of the present disclosure. It should be noted that, in the absence of conflict, the implementations and features in the present disclosure can be arbitrarily combined with each other.

With the development of aircraft technology, users can perform aerial photography by operating an aircraft to shoot videos from a unique perspective. By adjusting the angle and position of the aircraft in the spatial coordinate system, the shooting perspective of the video can be changed to shoot highlight segments. For example, segments where the aircraft is controlled to circle around a target object, or segments where the aircraft is controlled to shoot the target object from far to near or from near to far, and other segments of interest to the user, can all be configured as highlight segments.

Since the video is shot by aerial photography, there are few reference objects in the video, resulting in most of the images in the video being similar. During the process of video playback, users need to spend a lot of time locating highlight segments in the video, resulting in low efficiency in locating highlight segments.

In related technology, a video playback method is provided, including: displaying a progress bar during the playback of a target video. In response to a user’s click operation on the progress bar, the displayed image is switched to the image corresponding to the click operation. The user can switch the displayed image by continuously clicking on the progress bar until the image in the highlight segment is played. However, this method requires the user to perform multiple non-directional click operations until the highlight segment is played, making it difficult to locate the highlight segment in the target video.

In order to solve the above technical problems, the present disclosure provides a video playback method. During the playback of a target video, a flight trajectory map with a first highlight mark is displayed. The user only needs to determine the position of the first highlight mark to locate the highlight segment, thereby saving a lot of time and improving the efficiency of locating highlight segments.

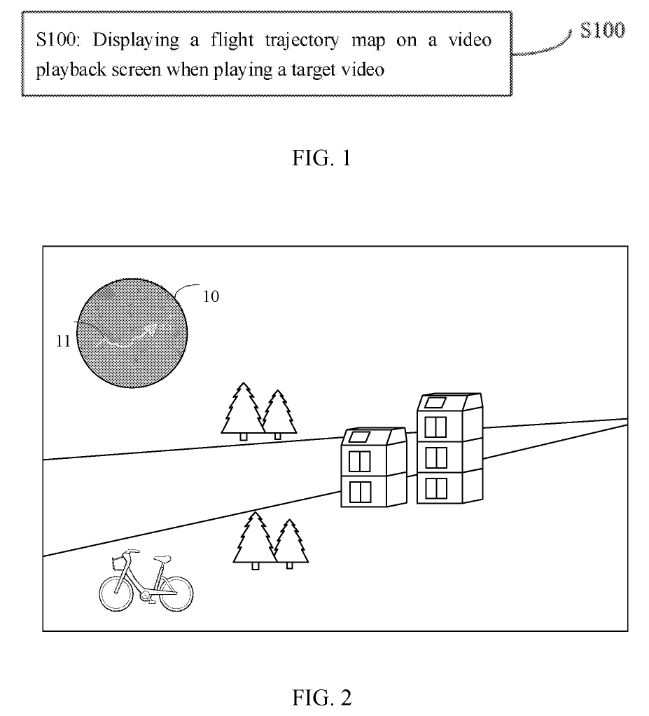

Some implementations of the present disclosure provide a video playback method, implemented on or applied to a video playback terminal. As shown in FIG. 1, the method includes:

S100, displaying a flight trajectory map on a video playback screen when playing a target video.

The flight trajectory map includes a flight trajectory, the flight trajectory includes a first highlight mark, and the first highlight mark is configured to locate one or more highlight segments in the target video.

In some implementations, during the playback of a target video shot by an aircraft, a flight trajectory map is displayed on the video playback screen to show the shooting position of the target video. The first highlight mark is displayed in the flight trajectory of the flight trajectory map, and the first highlight mark is configured to locate one or more highlight segments in the target video, so that the user can locate the highlight segment to be watched through the flight trajectory and the first highlight mark. Since the user can locate the highlight segment through the first highlight mark in the flight trajectory map during the playback of the target video, the efficiency of locating highlight segments is improved. At the same time, since the flight trajectory corresponds to the shooting position of the target video, the flight trajectory can also be configured as a progress bar for playing the target video, thereby reducing the complexity of video positioning.

The term “target video” as referred to in the present disclosure may refer to a video captured by an aircraft (such as an unmanned aerial vehicle, UAV) during flight, which is played back, previewed, analyzed, or processed on a video playback terminal. The target video may include both original segments and one or more highlight segments identified or marked by the system or the user.

In some implementations, the flight trajectory map is displayed in a small window. The small window refers to a window within the display screen that is of a smaller size than the entire screen. For example, the small window occupies one-third, one-fourth, one-fifth, one-tenth, one-twentieth of the size of the entire screen, or any size between any of the preceding two sizes. The shape of the small window may be square, rectangular, circular, oval, or any suitable size on the display screen. The flight trajectory map is generated during or after the process of the aircraft capturing the target video.

In some implementations, by displaying the flight trajectory map generated by the aircraft during or after the process of capturing the target video in a small window on the video playback screen, the flight trajectory map can reflect the shooting position of the target video to facilitate the positioning of highlight segments, thereby improving the efficiency of locating highlight segments.

According to some implementations, as shown in FIG. 2, the flight trajectory map 10 is displayed in a small window on the video playback screen. The flight trajectory map 10 can be positioned at a preset position on the video playback screen, or at a position set by the user in the video playback screen. The flight trajectory map 10 can include one or more first highlight marks 11, and the first highlight mark 11 indicates the start time and/or end time of a highlight segment in the target video. The user can locate the highlight segment in the target video through the first highlight mark 11 in the flight trajectory map 10. In the flight trajectory, one color can be configured to indicate the images of the target video that have been played, and another color can be configured to indicate the images of the target video that have not been played.

The term “first highlight mark” used herein may refer to a visual indication displayed on a flight trajectory map to mark one or more highlight segments in the target video. Each first highlight mark corresponds to a specific position or time point in the flight trajectory and is used to locate the start time and/or the end time of a highlight segment. As used in the present disclosure, the term “aircraft” may refer to an unmanned aerial vehicle (UAV), such as a drone.

In some implementations, the first highlight mark may be generated in a variety of ways, including but not limited to automatic and manual methods. For instance, the first highlight mark may be generated based on camera motion analysis of the aircraft, such as detecting patterns of circling, hovering, or sudden acceleration or deceleration during flight. Alternatively, the first highlight mark may be generated by detecting or tracking a shooting subject, such as a specific object, person, or landmark captured in the video. In some cases, the first highlight mark may be manually added by a user during or after video recording to indicate segments of personal interest.

According to some implementations of the present disclosure, during the flight of the aircraft, the world coordinate system and the flight trajectory can be determined. During or after the process of capturing the target video, the flight trajectory map is generated according to the world coordinate system and the flight trajectory.

In some implementations, the flight trajectory is associated with the playback progress of the target video, and the position mark in the flight trajectory is configured to locate or indicate the current playback position of the target video.

In some implementations, since each point in the flight trajectory corresponds one-to-one to the shooting position of the target video, and the shooting position may change over time. Each point in the flight trajectory corresponds to the playback time of the target video and can reflect the playback progress of the target video. By using the position mark to locate the current playback position of the target video, the user can determine the playback position and shooting position of the target video according to the position mark, thereby improving the effect of video positioning.

In some implementations, a segment mark in the flight trajectory map is configured to locate a segment in the target video shot by the aircraft at a fixed position.

In some implementations, since the aircraft may shoot a segment at a fixed position during the process of capturing the target video, it is impossible to reflect the segment in the flight trajectory map with a segment of trajectory. By displaying a segment mark in the flight trajectory map, the user can determine that the aircraft shot a segment in the target video at the fixed position according to the segment mark, thereby improving the efficiency of segment positioning.

In some implementations, the position mark includes a framing direction mark, and the direction of the framing direction mark is the framing direction corresponding to the picture of the target video being played.

In some implementations, since the framing direction of the target video obtained by the aircraft through aerial photography may change, the user cannot determine the framing direction corresponding to the picture of the target video being played in the flight trajectory map. By including a framing direction mark in the position mark, the user can determine the framing direction corresponding to the picture of the target video being played according to the direction of the framing direction mark, thereby improving the reliability of video playback.

In some implementations, the position mark includes a movement direction mark, and the direction of the movement direction mark is the flight direction in the flight trajectory map.

In some implementations, by including a movement direction mark in the position mark, the user can determine the flight trajectory corresponding to the picture of the target video to be played and the playback progress of the target video according to the movement direction mark, thereby improving the reliability of video positioning.

According to some implementations of the present disclosure, as shown in FIG. 3, the flight trajectory map 10 can include a position mark, and the position mark includes a framing direction mark 12 and a movement direction mark 13. The user can determine the framing direction corresponding to the picture of the target video being played according to the direction of the framing direction mark 12 in the flight trajectory map 10. The user can determine the flight direction of the aircraft in the flight trajectory map 10 and the playback progress of the target video according to the direction of the movement direction mark 13 in the flight trajectory map 10. The starting point and ending point of the flight trajectory correspond to the start time and end time of the target video, respectively. The starting point of the flight trajectory is the position where the target video starts to be captured, and the ending point of the flight trajectory is the position where the target video ends.

Taking a panoramic aircraft as an example, during the panoramic shot, the 360-degree surrounding environment of the panoramic aircraft can be mapped to a 360-degree spherical model. That is, each 360-degree (panoramic) aerial video frame can be projected onto the spherical model. A framing angle may be oriented toward any direction on the surface of the spherical model. By superimposing the framing angle onto the spherical model, the region of the aerial video frame corresponding to that framing angle can be selected, thereby obtaining a target video frame after frame selection. In some implementations, using the spherical model, image content in the aerial video frame corresponding to the framing angle can be extracted, and post-processing (such as distortion correction) can be performed on the extracted image content, so as to obtain a target video frame corresponding to that framing angle. A plurality of target video frames obtained by frame selection from multiple aerial video frames together form a target video.

It should be noted that, in addition to the spherical model, panoramic images captured by the panoramic aircraft may also be projected onto other types of models for frame selection. Such projection methods may include, for example, equirectangular projection, cylindrical projection, polyhedral projection, stereographic/polar projection, pyramid projection, and the like.

Taking the panoramic spherical model as an example, although the panoramic aircraft can capture a 360-degree panoramic view of the surrounding environment, most display devices have a limited display area. Therefore, such display devices are typically used to display image content corresponding to a local framing angle within the panoramic image. When controlling which framing angle’s image content is displayed on a display device, a virtual camera may be configured to perform frame selection within the panoramic spherical model. Accordingly, the framing angle adopted by the virtual camera within the panoramic spherical model determines the image content corresponding to that framing angle that is displayed by the display device. In some implementations, the framing angle may be defined, for instance, by the orientation angles of the virtual camera (such as yaw, pitch, and roll), the quaternion of the virtual camera, the field of view of the virtual camera (such as horizontal field of view or vertical field of view), or parameters of the virtual camera in a spherical coordinate system (such as polar angle or azimuth angle).

Taking other aircrafts as examples, unlike panoramic aircrafts capable of cpaturing 360-degree of the surrounding environment, image acquisition devices on other aircrafts can usually capture only a limited framing angle of the surrounding environment. Accordingly, frame selection for such aircrafts may be changed by adjusting a gimbal mounted on the aircraft, or by adjusting changes in the pose of the aircraft.

In some implementations, the number of the first highlight mark (e.g., shown as 11 in FIG. 3) corresponding to each highlight segment is one, and the first highlight mark indicates the start time of the corresponding highlight segment.

In some implementations, by using one first highlight mark as the start time of a highlight segment in the flight trajectory map, the number of first highlight marks in the flight trajectory map is small, making it easier for the user to locate highlight segments, thereby improving the efficiency of locating highlight segments and reducing the complexity of displaying the flight trajectory map.

In some implementations, the number of the first highlight marks corresponding to each highlight segment is two, and the two first highlight marks indicate respectively the start time and the end time of the corresponding highlight segment.

In some implementations, by using two first highlight marks as the start time and end time of a highlight segment in the flight trajectory map, the user can locate a highlight segment according to the two first highlight marks to determine the duration of the highlight segment and the shooting path, thereby improving the reliability of locating highlight segments.

In some implementations, different highlight segments correspond to different colors of the first highlight mark.

In some implementations, since there may be multiple highlight segments in the target video, if the colors of the first highlight marks are the same, it is difficult for the user to determine the corresponding highlight segment according to the first highlight mark. In addition, in the case where each highlight segment corresponds to two first highlight marks, it is difficult for the user to distinguish whether the first highlight mark is the start time or end time of the corresponding highlight segment. By setting different colors for the first highlight marks corresponding to different highlight segments, the user can distinguish different highlight segments according to the color of the first highlight mark, thereby improving the efficiency of locating highlight segments.

In some implementations, different highlight segments correspond to different shapes of the first highlight mark.

In some implementations, since there may be multiple highlight segments in the target video, if the shapes of the first highlight marks are the same, it is difficult for the user to determine the corresponding highlight segment according to the first highlight mark. In addition, in the case where each highlight segment corresponds to two first highlight marks, it is difficult for the user to distinguish whether the first highlight mark is the start time or end time of the corresponding highlight segment. By setting different shapes for the first highlight marks corresponding to different highlight segments, the user can distinguish different highlight segments according to the shape of the first highlight mark, thereby improving the efficiency of locating highlight segments.

According to some implementations of the present disclosure, the colors and shapes of the first highlight marks corresponding to different highlight segments are both different.

In some implementations, after displaying the flight trajectory map on the video playback screen in operation S100, the video playback method further includes:

in response to a user performing a preview operation at a first position of the flight trajectory, displaying a target preview screen corresponding to the first position or a target preview video within a preset time from the first position on the flight trajectory map.

In some implementations, when the user needs to preview the target preview screen corresponding to the first position, a preview operation is performed at the first position to avoid changing the picture of the target video being played. Or, when the user needs to preview the target preview video within a preset time from the first position, a preview operation is performed at the first position to avoid changing the picture of the target video being played. In response to the user performing a preview operation at the first position of the flight trajectory, the target preview screen corresponding to the first position or the target preview video within a preset time from the first position is displayed on the flight trajectory map, so that the user can preview the target preview screen or target preview video corresponding to the first position through the small window area. By displaying the target preview screen or target preview video corresponding to the first position on the flight trajectory map for preview, the user can preview without adjusting the playback progress of the target video and avoid playing images that the user does not need to watch, thereby improving the effect of video positioning.

In some implementations, the video playback terminal includes a head-mounted display device, and the preview operation includes a ray emission operation by a controller of the aircraft or an eye movement operation.

In some implementations, since the head-mounted display device can play the target video, and in the case where the target video is a panoramic video, the head-mounted display device has a better playback effect, the video playback terminal for playing the target video includes a head-mounted display device. Since the user cannot perform a preview operation by touch, it is necessary to perform a preview operation through the controller of the aircraft or the eye-tracking function of the head-mounted display device. After the user operates the controller of the aircraft, the ray emitted by the controller of the aircraft will focus on the virtual screen of the head-mounted display device. When the ray emitted by the controller of the aircraft focuses on the first position of the flight trajectory, the user wants to preview the picture in the target video corresponding to the first position, and the ray emission operation by the controller of the aircraft is configured as the preview operation. Or, when the user's eyes look at the first position of the flight trajectory, the user wants to preview the picture in the target video corresponding to the first position, and the eye movement operation is configured as the preview operation. By using the ray emission operation by the controller of the aircraft or the eye movement operation as the preview operation, the preview operation corresponds to the head-mounted display device to quickly display the preview screen, thereby reducing the complexity of video positioning.

In some implementations, the video playback terminal includes a mobile phone or a camera, and the preview operation includes a long-press operation.

In some implementations, since the mobile phone and camera can play the target video, and the user can perform a preview operation by touch, the video playback terminal for playing the target video includes a mobile phone or a camera. In order to prevent the preview operation from changing the playback progress of the target video, the long-press operation is configured as the preview operation to avoid conflict with the click operation. By using the long-press operation as the preview operation, the preview operation corresponds to the mobile phone and camera to quickly display the preview screen, thereby reducing the complexity of video positioning.

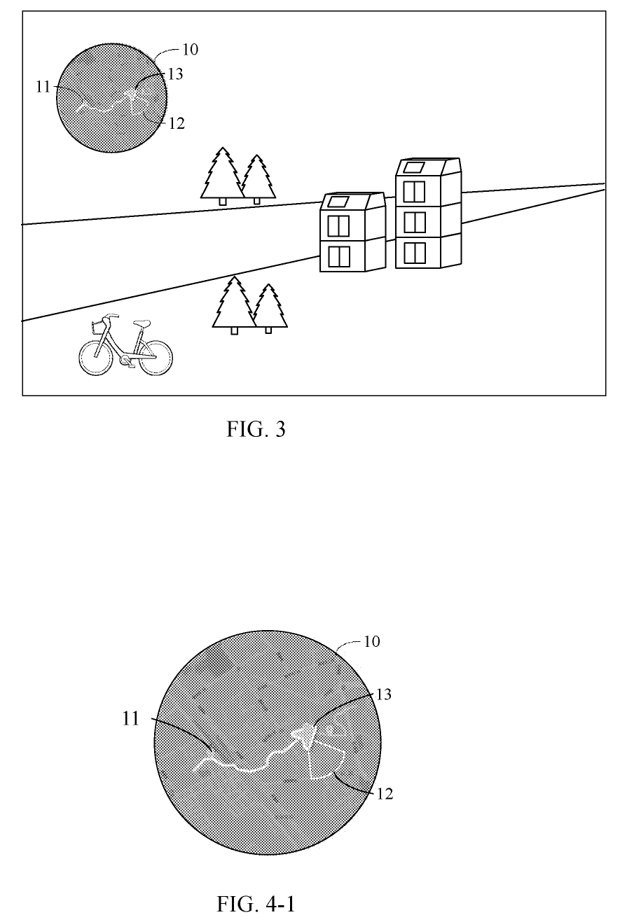

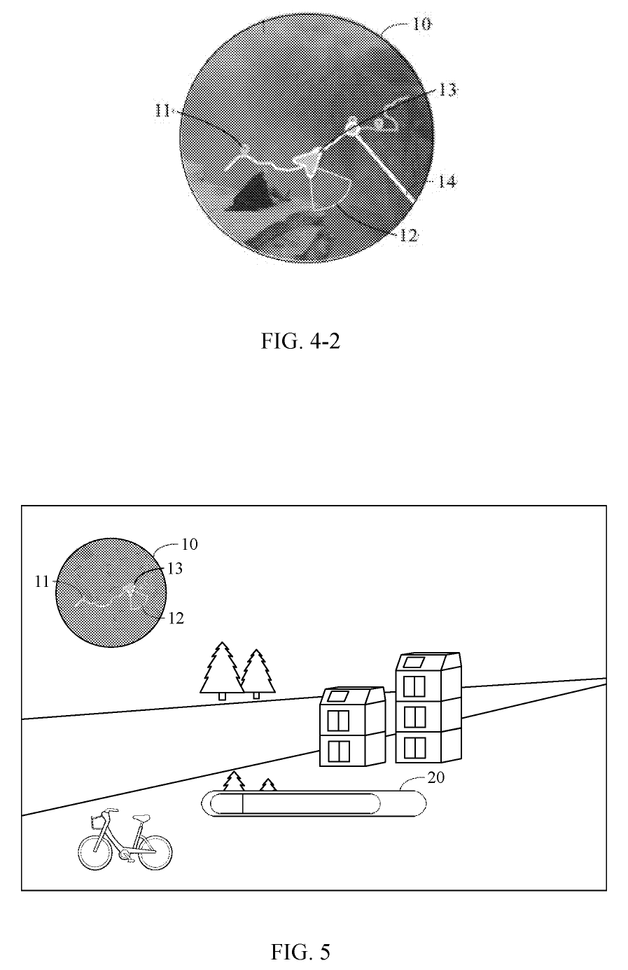

According to some implementations of the present disclosure, as shown in FIG. 4-1 and FIG. 4-2, in response to the user performing a preview operation at the first position of the flight trajectory, the map in the flight trajectory map 10 changes to the picture in the target video corresponding to the first position, and this picture can be a preview image of the target video. In FIG. 4-2, the ray pointing to the second position in the flight trajectory is the ray 14 emitted by the controller of the aircraft.

In some implementations, after displaying the flight trajectory map on the video playback screen in operation S100, the video playback method further includes:

in response to a user performing a click operation at a second position of the flight trajectory, switching the picture of the target video playback to the picture corresponding to the second position.

In some implementations, since the flight trajectory is the overall progress of the target video, when the user needs to adjust the playback progress of the target video, a click operation can be performed on the flight trajectory. In response to the user performing a click operation at the second position of the flight trajectory, the picture of the target video playback is switched to the picture corresponding to the second position, and the position mark is moved to the second position to adjust the playback progress of the target video. By performing a click operation at the second position of the flight trajectory to adjust the playback progress of the target video, the method for adjusting the playback progress of the target video is simple, thereby reducing the complexity of video positioning. At the same time, since the target video is a video shot by the aircraft along the flight trajectory, after the user performs a click operation at the second position, the picture shot at the second position can be played so that the user can select the picture to be played according to the shooting position, thereby improving the effect of video playback.

According to some implementations of the present disclosure, the video playback terminal includes a head-mounted display device, and the click operation includes a click operation performed by the user on the trigger button of the controller of the aircraft. Or, the video playback terminal includes a mobile phone or a camera, and the click operation includes a click operation performed by the user on the screen of the mobile phone or camera.

In some implementations, after displaying the flight trajectory map on the video playback screen in operation S100, the video playback method further includes:

in response to a user performing a click operation on the first highlight mark, playing the highlight segment corresponding to the clicked first highlight mark.

The direction of the framing direction mark of the position mark in the flight trajectory map is the framing direction corresponding to the picture of the highlight segment being played.

In some implementations, when the user needs to play a highlight segment in the target video, the user will perform a click operation on the first highlight mark. Since the number of highlight segments and the corresponding first highlight marks may be multiple, in response to the user performing a click operation on the first highlight mark, the highlight segment corresponding to the clicked first highlight mark is played. Since the framing direction of the target video may change, the user can determine the framing direction corresponding to the picture of the highlight segment being played according to the direction of the framing direction mark. By performing a click operation on the first highlight mark to play the highlight segment, the method for playing the highlight segment is simple, thereby reducing the complexity of playing highlight segments.

In some implementations, during the process of playing the target video, the video playback method further includes: displaying a progress bar for playing the target video on the video playback screen.

In some implementations, since the aircraft may shoot a segment in the target video at a fixed position during the process of capturing the target video and the flight trajectory may not be a straight line, it is difficult to accurately determine the playback progress of the target video according to the flight trajectory. By displaying a progress bar for playing the target video while displaying the flight trajectory map, the user can accurately determine the playback progress of the target video according to the progress bar, thereby improving the reliability of video playback.

According to some implementations of the present disclosure, as shown in FIG. 5, in the video playback screen, in addition to displaying the flight trajectory map 10 in a small window on the video playback screen, a progress bar 20 for playing the target video is also displayed. The progress bar 20 can be located at a preset position on the video playback screen, or at a position set by the user in the video playback screen, and does not overlap with the flight trajectory map 10.

In some implementations, after displaying the progress bar for playing the target video on the video playback screen as described above, the video playback method further includes:

during the process of playing an original segment in the target video, in response to a user clicking a switch control in the progress bar for playing the target video, playing the highlight segment; and

during the process of playing the highlight segment, in response to a user clicking the switch control, playing the original segment.

In some implementations, since the user may only want to watch the original segment or the highlight segment during the playback of the target video, the progress bar will display a switch control to switch between the original segment and the highlight segment. During the process of playing the original segment, in response to the user clicking the switch control, only the highlight segment is played to switch from the original segment to the highlight segment. During the process of playing the highlight segment, in response to the user clicking the switch control, the original segment is played to switch from the highlight segment to the original segment. By switching between the original segment and the highlight segment through the switch control in the progress bar, the user does not need to perform multiple image jump operations during the playback of the target video to switch, thereby improving the efficiency of segment switching.

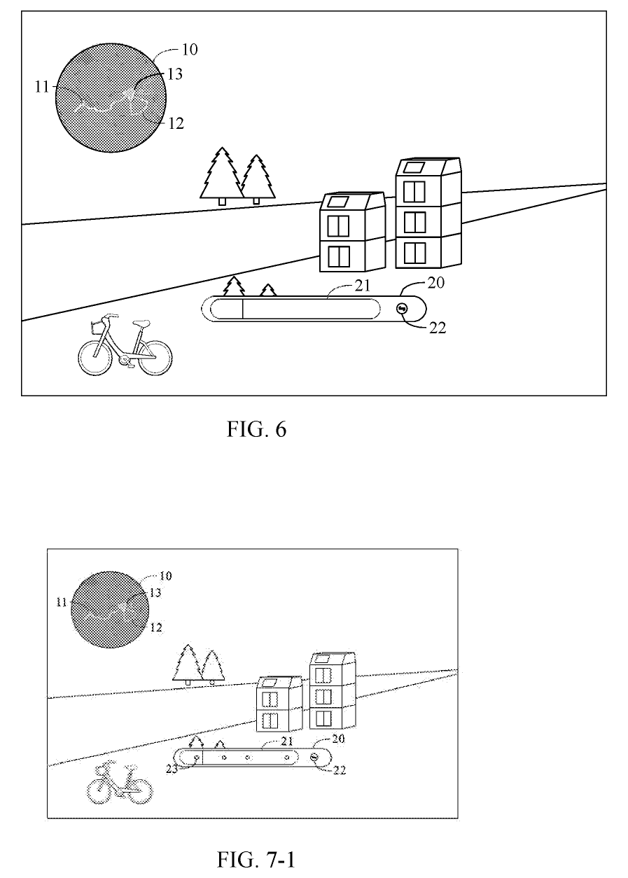

According to some implementations of the present disclosure, as shown in FIG. 6, in the progress bar 20, in addition to displaying the playback progress bar 21, a switch control 22 is also displayed. During the process of playing the original segment, in response to the user clicking the switch control 22, the highlight segment is played, and the original segment is stopped. During the process of playing the highlight segment, in response to the user clicking the switch control 22, the original segment is played, and the highlight segment is stopped.

According to some implementations of the present disclosure, the original segment can be the original video in the target video shot by the aircraft without being cropped, or it can be a portion of the cropped original video.

In some implementations, the number of highlight segments is multiple. The playing of the highlight segment as described above can be determined as follows:

playing a first highlight segment after the current playback position of the original segment.

In some implementations, since the images before the current playback position of the original segment may have already been played, and the highlight segments before the current playback position may have already been played and are not the segments the user wants to watch. In response to the user clicking the switch control, the first highlight segment after the current playback position of the original segment is played, so that the user can watch a new highlight segment. By playing the next highlight segment after the current playback position, the user can watch a new highlight segment without selecting the highlight segment, thereby improving the effect of video playback.

According to some implementations of the present disclosure, the playing of the highlight segment as described above can also play the first highlight segment before the current playback position of the original segment, or play the first highlight segment among all highlight segments.

In some implementations, the playing of the original segment as described above is determined as follows:

playing the original segment that is the same as the picture of the highlight segment.

In some implementations, since the highlight segment is a portion of the original segment, during the process of playing the highlight segment, there is a picture in the original segment that is the same as the current playback position of the highlight segment. In response to the user clicking the switch control, the original segment that is the same as the picture of the highlight segment is played, so that the user can watch a continuous picture. By playing the original segment that is the same as the picture of the highlight segment, there will be no image jump during the playback of the target video and no need to adjust the progress, thereby improving the effect of video playback.

In some implementations, during the playing of the highlight segment as described above, the video playback method further includes: switching the progress bar of the original segment to the progress bar of the highlight segment.

During the playing of the original segment as described above, the video playback method further includes: switching the progress bar of the highlight segment to the progress bar of the original segment.

In some implementations, since the highlight segment is a portion of the original segment and is at a different position, the times required to play the original segment and the highlight segment are different. In some examples, the progress corresponding to the same picture displayed by the original segment and the highlight segment is different. In response to the user clicking the switch control, in addition to playing the highlight segment, the progress bar of the original segment needs to be switched to the progress bar of the highlight segment so that the picture played by the highlight segment corresponds to the progress. Or, in response to the user clicking the switch control, in addition to playing the original segment, the progress bar of the highlight segment needs to be switched to the progress bar of the original segment so that the picture played by the original segment corresponds to the progress. By switching the progress bar after clicking the switch control, the picture played by the segment can correspond to the progress, thereby improving the reliability of video playback.

In some implementations, the progress bar of the original segment includes a second highlight mark, and the second highlight mark is configured to locate the highlight segment.

In some implementations, since the highlight segment is a portion of the original segment, and compared to the flight trajectory map, the progress bar can more intuitively show the playback progress of the target video. By displaying the second highlight mark in the progress bar of the original segment, the second highlight mark is configured to locate the highlight segment in the target video, so that the user can locate the highlight segment to be watched through the progress bar of the original segment and the second highlight mark. Since the user can also locate the highlight segment through the second highlight mark in the progress bar of the original segment during the process of playing the original segment, the efficiency of locating highlight segments is improved.

According to some implementations of the present disclosure, the number of second highlight marks corresponding to each highlight segment is one, and the second highlight mark indicates the start time of the corresponding highlight segment. Alternatively, the number of second highlight marks corresponding to each highlight segment is two, and the two second highlight marks indicate respectively the start time and end time of the corresponding highlight segment.

According to some implementations of the present disclosure, different highlight segments correspond to different colors of the second highlight mark, different highlight segments correspond to different shapes of the second highlight mark, or different highlight segments correspond to the combination of different colors and different shapes of the second highlight mark.

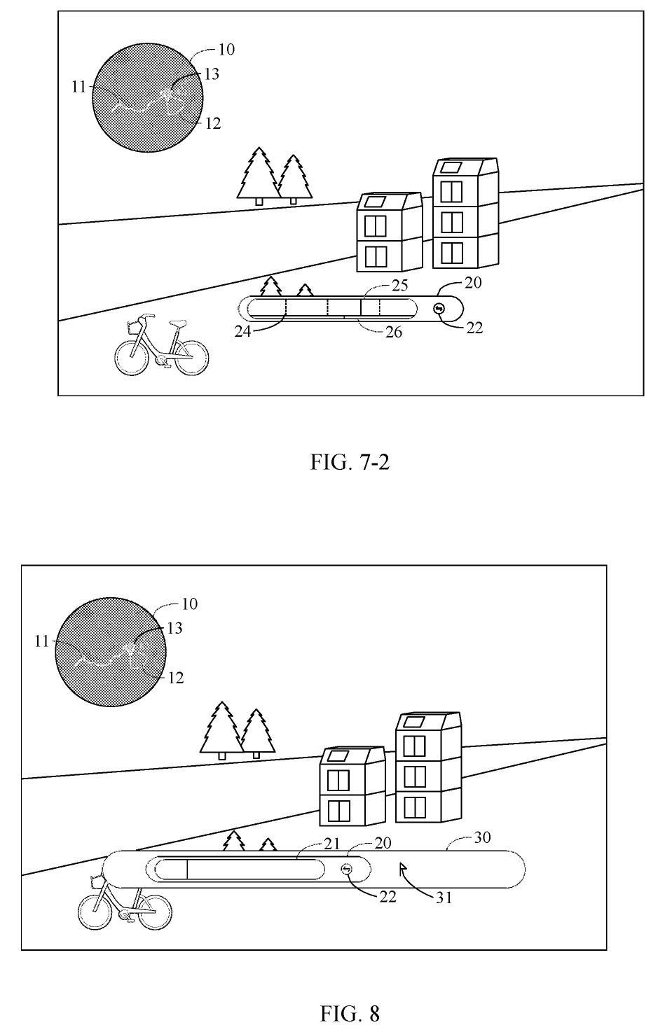

According to some implementations of the present disclosure, as shown in FIG. 7-1, in the progress bar 20 of the original segment, in addition to displaying the playback progress bar 21 and the switch control 22, a second highlight mark 23 is also displayed. Each second highlight mark 23 indicates the start time of the corresponding highlight segment. In response to the user clicking the second highlight mark 23, the highlight segment corresponding to the clicked second highlight mark 23 is played.

The first highlight mark serves as a space-oriented indicator that allows the user to identify highlight segments of the target video based on the flight path of the aircraft (e.g., a UAV). By referencing the first highlight mark on the flight trajectory map, users can understand where in the flight path the highlights occurred and visually locate segments of interest in a spatial context.

On the other hand, the second highlight mark serves as a time-oriented indicator displayed on the video playback progress bar. In some implementations, the second highlight mark helps users to understand when during the flight the highlights occurred. In some implementations, it allows users to quickly jump to highlight segments based on the temporal position within the video timeline, enabling efficient access to key moments through time-based navigation.

In some implementations, the progress bar of the highlight segment includes a progress mark, and the progress mark is configured to locate the start time and/or end time of the highlight segment.

In some implementations, since the highlight segment is a portion of the original segment and the number may be multiple, the progress of multiple highlight segments is set in the progress bar of the highlight segment, making it difficult to distinguish different highlight segments. By displaying a progress mark in the progress bar of the highlight segment, the progress mark is configured to locate the start time and/or end time of the highlight segment, so that the user can select the highlight segment to be watched and select the playback progress of the highlight segment through the progress mark. Since the user can select different highlight segments and their playback progress through the progress mark in the progress bar of the highlight segment during the process of playing the highlight segment, the efficiency of selecting highlight segments is improved.

In some implementations, the progress bar of the highlight segment further includes a first sub-progress bar and a second sub-progress bar, the first sub-progress bar is configured to display the current progress of the played highlight segment, and the second sub-progress bar is configured to display the current progress of the original segment corresponding to the current progress of the played highlight segment.

In some implementations, since the highlight segment is a portion of the original segment, the current progress of the highlight segment corresponds to the current progress of the original segment. By displaying the first sub-progress bar and the second sub-progress bar in the progress bar of the highlight segment, the second sub-progress bar is configured to display the current progress of the original segment corresponding to the current progress of the played highlight segment, so that the user can determine the current playback position of the highlight segment in the current playback position of the original segment through the second sub-progress bar. Since the user can determine the corresponding current progress of the original segment through the second sub-progress bar of the highlight segment during the process of playing the highlight segment, the reliability of video playback is improved.

According to some implementations of the present disclosure, as shown in FIG. 7-2, in the progress bar 20 of the highlight segment, in addition to displaying the switch control 22, a progress mark 24, a first sub-progress bar 25, and a second sub-progress bar 26 are also displayed. The first sub-progress bar 25 and the second sub-progress bar 26 constitute the playback progress bar 21. The user can locate different highlight segments in the target video through two adjacent progress marks 24, the first progress mark 24, or the last progress mark 24 in the progress bar 20. The user can determine the current progress of the highlight segment being played through the first sub-progress bar 25 in the progress bar 20. The user can determine the current progress of the original segment corresponding to the current progress of the highlight segment being played through the second sub-progress bar 26 in the progress bar 20.

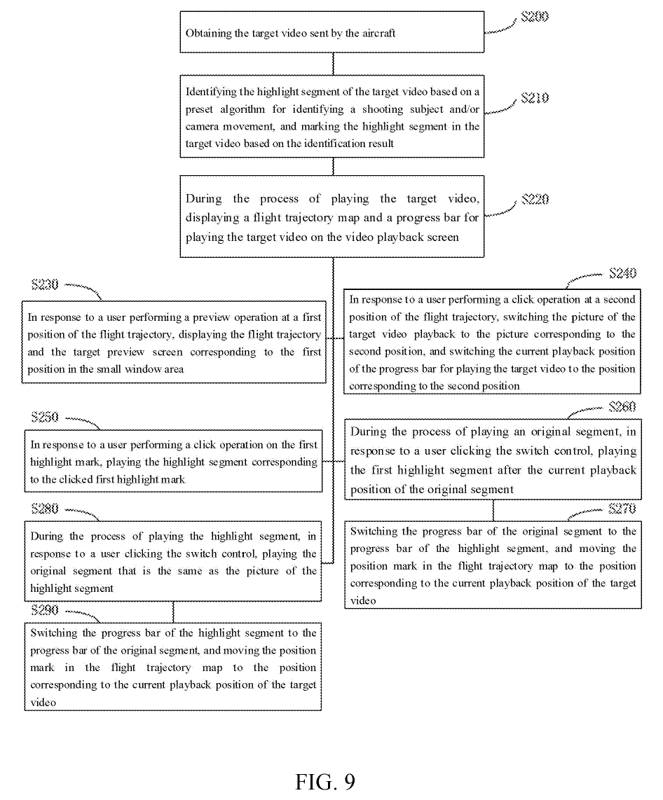

According to some implementations of the present disclosure, as shown in FIG. 8, during the process of playing the target video, a control bar 30 is displayed, and the progress bar 20 is located in the control bar 30. The control bar 30 also includes a marking control 31, and the marking control 31 is configured to mark the original segment during the process of playing the original segment to generate a highlight segment.

In some implementations, the video playback method further includes:

in response to a user clicking a switch control in the progress bar for playing the target video, moving the position mark in the flight trajectory map to the position corresponding to the current playback position of the target video.

In some implementations, since the flight trajectory map and the progress bar are displayed simultaneously during the process of playing the target video, and the position of the position mark in the flight trajectory is related to the playback progress of the target video. In response to the user clicking the switch control in the progress bar for playing the target video, in addition to switching the segment, the position mark in the flight trajectory map is also moved to the position corresponding to the current playback position of the target video. By adjusting the position of the position mark after clicking the switch control, the position of the position mark in the flight trajectory corresponds to the playback progress of the target video, thereby improving the reliability of video playback.

In some implementations, the video playback method further includes:

in response to a user performing a click operation at a second position of the flight trajectory, switching the current playback position of the progress bar for playing the target video to the position corresponding to the second position.

In some implementations, since the flight trajectory map and the progress bar are displayed simultaneously during the process of playing the target video, and the position of the position mark in the flight trajectory is related to the playback progress of the target video. In response to the user performing a click operation at the second position of the flight trajectory, in addition to adjusting the playback progress and displayed picture, the current progress of the progress bar for playing the target video is also switched to the progress corresponding to the second position. By adjusting the current progress of the progress bar after performing a click operation at the second position of the flight trajectory, the progress of the progress bar corresponds to the playback progress of the target video, thereby improving the reliability of video playback.

In some implementations, before displaying the flight trajectory map on the video playback screen in operation S100, the video playback method further includes:

obtaining the target video sent by the aircraft; and

identifying the highlight segment of the target video based on a preset algorithm for identifying a shooting subject and/or camera movement, and marking the highlight segment in the target video based on the identification result.

In some implementations, since it is difficult to mark the target video to obtain highlight segments after the aircraft captures the target video, the target video without highlight segments is sent to the video playback terminal. Since the target video captured by the aircraft contains a lot of content that the user is not interested in, it is necessary to identify the content that the user is interested in. The highlight segment of the target video is identified based on a preset algorithm for identifying a shooting subject and/or camera movement, and the content that the user is interested in is identified based on the shooting subject and/or camera movement. The highlight segment is marked in the target video based on the identification result to obtain the highlight segment. By automatically identifying and marking the highlight segment based on a preset algorithm, the user does not need to perform the marking operation, thereby improving the user experience. At the same time, since the highlight segment is obtained by marking and does not need to be generated separately, the volume occupied by the highlight segment and the time required for segment switching are reduced, thereby improving the effect of video playback.

In some implementations, before displaying the flight trajectory map on the video playback screen in operation S100, the video playback method further includes:

obtaining the target video sent by the aircraft; and

in response to a user performing a highlight marking operation on a segment in the target video, obtaining the highlight segment.

In some implementations, since it is difficult to mark the target video to obtain highlight segments after the aircraft captures the target video, the target video without highlight segments is sent to the video playback terminal. Since the target video captured by the aircraft contains a lot of content that the user is not interested in, it is necessary to identify the content that the user is interested in. In response to a user performing a highlight marking operation on a segment in the target video, the highlight segment is marked in the target video to obtain the highlight segment. By allowing the user to actively mark the highlight segment, the highlight segment is truly the segment that the user is interested in, thereby improving the user experience.

The implementations of the present disclosure provide a video playback method, applied to a video playback terminal. As shown in FIG. 9, the method includes the following operations.

S200, obtaining the target video sent by the aircraft.

S210, identifying the highlight segment of the target video based on a preset algorithm for identifying a shooting subject and/or camera movement, and marking the highlight segment in the target video based on the identification result.

S220, during the process of playing the target video, displaying a flight trajectory map and a progress bar for playing the target video on the video playback screen.

S230, in response to a user performing a preview operation at a first position of the flight trajectory, displaying the flight trajectory and the target preview screen corresponding to the first position in the small window area.

S240, in response to a user performing a click operation at a second position of the flight trajectory, switching the picture of the target video playback to the picture corresponding to the second position, and switching the current playback position of the progress bar for playing the target video to the position corresponding to the second position.

S250, in response to a user performing a click operation on the first highlight mark, playing the highlight segment corresponding to the clicked first highlight mark.

S260, during the process of playing an original segment, in response to a user clicking the switch control, playing the first highlight segment after the current playback position of the original segment.

S270, switching the progress bar of the original segment to the progress bar of the highlight segment, and moving the position mark in the flight trajectory map to the position corresponding to the current playback position of the target video.

S280, during the process of playing the highlight segment, in response to a user clicking the switch control, playing the original segment that is the same as the picture of the highlight segment.

S290, switching the progress bar of the highlight segment to the progress bar of the original segment, and moving the position mark in the flight trajectory map to the position corresponding to the current playback position of the target video.

In some implementations, since it is difficult to mark the target video to obtain highlight segments after the aircraft captures the target video, the target video sent by the aircraft is obtained for marking the highlight segment. The highlight segment of the target video is identified based on a preset algorithm for identifying a shooting subject and/or camera movement, and the highlight segment is marked in the target video based on the identification result. During the process of playing the target video, a flight trajectory map and a progress bar for playing the target video are displayed on the video playback screen. In response to a user performing a preview operation at a first position of the flight trajectory, the flight trajectory and the target preview screen corresponding to the first position are displayed in the small window area, so that the user can preview the screen corresponding to the first position through the small window area. In response to a user performing a click operation at a second position of the flight trajectory, the picture of the target video playback is switched to the picture corresponding to the second position, and the current playback position of the progress bar for playing the target video is switched to the position corresponding to the second position. In response to a user performing a click operation on the first highlight mark, the highlight segment corresponding to the clicked first highlight mark is played, so that the highlight segment is played through the first highlight mark. During the process of playing an original segment, in response to a user clicking the switch control, the first highlight segment after the current playback position of the original segment is played. The progress bar of the original segment is switched to the progress bar of the highlight segment, and the position mark in the flight trajectory map is moved to the position corresponding to the current playback position of the target video, so that the progress bar and the position mark correspond to the current playback position of the target video. During the process of playing the highlight segment, in response to a user clicking the switch control, the original segment that is the same as the picture of the highlight segment is played. The progress bar of the highlight segment is switched to the progress bar of the original segment, and the position mark in the flight trajectory map is moved to the position corresponding to the current playback position of the target video, so that the progress bar and the position mark correspond to the current playback position of the target video. Since the user can locate the highlight segment through the first highlight mark in the flight trajectory map during the process of playing the target video, the efficiency of locating highlight segments is improved. At the same time, since the flight trajectory corresponds to the shooting position of the target video, the flight trajectory can also be configured as a progress bar for playing the target video, thereby reducing the complexity of video positioning.

In an exemplary implementation, a video playback terminal is provided. The video playback terminal includes a memory and a processor. The memory is configured to store program instructions. The processor calls the program instructions, and when the program instructions are executed, the processor is configured to execute:

displaying a flight trajectory map on a video playback screen when playing a target video.

The flight trajectory map includes a flight trajectory, the flight trajectory includes a first highlight mark, and the first highlight mark is configured to locate one or more highlight segments in the target video.

In an exemplary implementation, the flight trajectory map is displayed in a small window. The flight trajectory map is generated during or after the process of the aircraft capturing the target video.

In an exemplary implementation, the flight trajectory is associated with the playback progress of the target video, and the position mark in the flight trajectory is configured to locate the current playback position of the target video.

In an exemplary implementation, the position mark includes a framing direction mark, and the direction of the framing direction mark is the framing direction corresponding to the picture of the target video being played.

In an exemplary implementation, the position mark includes a movement direction mark, and the direction of the movement direction mark is the flight direction in the flight trajectory map.

In an exemplary implementation, the number of the first highlight mark corresponding to each highlight segment is one, and the first highlight mark is the start time of the corresponding highlight segment.

In an exemplary implementation, the number of the first highlight marks corresponding to each highlight segment is two, and the two first highlight marks are respectively the start time and the end time of the corresponding highlight segment.

In an exemplary implementation, the colors and/or shapes of the first highlight marks corresponding to different highlight segments are different.

In an exemplary implementation, the processor calls the program instructions, and when the program instructions are executed, the processor is configured to execute:

in response to a user performing a preview operation at a first position of the flight trajectory, displaying a target preview screen corresponding to the first position or a target preview video within a preset time from the first position on the flight trajectory map.

In an exemplary implementation, the video playback terminal includes a head-mounted display device, and the preview operation includes a ray emission operation by a controller of the aircraft or an eye movement operation.

In an exemplary implementation, the video playback terminal includes a mobile phone or a camera, and the preview operation includes a long-press operation.

In an exemplary implementation, the processor calls the program instructions, and when the program instructions are executed, the processor is configured to execute:

in response to a user performing a click operation at a second position of the flight trajectory, switching the picture of the target video playback to the picture corresponding to the second position.

In an exemplary implementation, the processor calls the program instructions, and when the program instructions are executed, the processor is configured to execute:

in response to a user performing a click operation on the first highlight mark, playing the highlight segment corresponding to the clicked first highlight mark.

The direction of the framing direction mark of the position mark in the flight trajectory map is the framing direction corresponding to the picture of the highlight segment being played.

In an exemplary implementation, the processor calls the program instructions, and when the program instructions are executed, the processor is configured to execute:

displaying a progress bar for playing the target video on the video playback screen.

In an exemplary implementation, the processor calls the program instructions, and when the program instructions are executed, the processor is configured to execute:

during the process of playing an original segment in the target video, in response to a user clicking a switch control in the progress bar for playing the target video, playing the highlight segment; and

during the process of playing the highlight segment, in response to a user clicking the switch control, playing the original segment.

In an exemplary implementation, the processor calls the program instructions, and when the program instructions are executed, the processor is configured to execute:

playing a first highlight segment after the current playback position of the original segment.

In an exemplary implementation, the processor calls the program instructions, and when the program instructions are executed, the processor is configured to execute:

playing the original segment that is the same as the picture of the highlight segment.

In an exemplary implementation, the processor calls the program instructions, and when the program instructions are executed, the processor is configured to execute:

switching the progress bar of the original segment to the progress bar of the highlight segment.

In an exemplary implementation, the processor calls the program instructions, and when the program instructions are executed, the processor is configured to execute:

switching the progress bar of the highlight segment to the progress bar of the original segment.

In an exemplary implementation, the processor calls the program instructions, and when the program instructions are executed, the processor is configured to execute so that:

the progress bar of the highlight segment includes a progress mark, and the progress mark is configured to locate the start time and/or end time of the highlight segment.

In an exemplary implementation, the progress bar of the highlight segment further includes a first sub-progress bar and a second sub-progress bar, the first sub-progress bar is configured to display the current progress of the played highlight segment, and the second sub-progress bar is configured to display the current progress of the original segment corresponding to the current progress of the played highlight segment.

In an exemplary implementation, the processor calls the program instructions, and when the program instructions are executed, the processor is configured to execute:

in response to a user clicking a switch control in the progress bar for playing the target video, moving the position mark in the flight trajectory map to the position corresponding to the current playback position of the target video.

In an exemplary implementation, the processor calls the program instructions, and when the program instructions are executed, the processor is configured to execute:

in response to a user performing a click operation at a second position of the flight trajectory, switching the current playback position of the progress bar for playing the target video to the position corresponding to the second position.

In an exemplary implementation, the processor calls the program instructions, and when the program instructions are executed, the processor is configured to execute:

obtaining the target video sent by the aircraft; and

identifying the highlight segment of the target video based on a preset algorithm for identifying a shooting subject and/or camera movement, and marking the highlight segment in the target video based on the identification result.

In an exemplary implementation, the processor calls the program instructions, and when the program instructions are executed, the processor is configured to execute:

obtaining the target video sent by the aircraft; and

in response to a user performing a highlight marking operation on a segment in the target video, obtaining the highlight segment.

In an exemplary implementation, a control terminal is provided, and the control terminal is connected to the video playback terminal as described above.

In an exemplary implementation, a video playback system is provided, and the video playback system includes a video playback terminal and a control terminal, and the control terminal is connected to the video playback terminal.

The control terminal is configured to, in response to a user's playback operation, send a first playback control signal to the video playback terminal.

The video playback terminal is configured to play a target video based on the received first playback control signal and display a flight trajectory map on a video playback screen.

The flight trajectory map includes a flight trajectory, the flight trajectory includes a first highlight mark, and the first highlight mark is configured to locate one or more highlight segments in the target video.

In an exemplary implementation, the control terminal is configured to, in response to a user performing a preview operation at a first position of the flight trajectory, send a preview control signal to the video playback terminal.

The video playback terminal is configured to, based on the received preview control signal, display a target preview screen corresponding to the first position or a target preview video within a preset time from the first position on the flight trajectory map.

In an exemplary implementation, the video playback terminal includes a head-mounted display device, and the preview operation includes a ray emission operation by the control terminal.

In an exemplary implementation, the control terminal is configured to, in response to a user performing a click operation at a second position of the flight trajectory, send a first jump control signal to the video playback terminal.

The video playback terminal is configured to, based on the received first jump control signal, switch the picture of the target video playback to the picture corresponding to the second position.

In an exemplary implementation, the control terminal is configured to, in response to a user clicking the first highlight mark, send a second playback control signal to the video playback terminal.

The video playback terminal is configured to, based on the received second playback control signal, play the highlight segment corresponding to the clicked first highlight mark.

The direction of the framing direction mark of the position mark in the flight trajectory map is the framing direction corresponding to the picture of the highlight segment being played.

In an exemplary implementation, the control terminal is configured to: during the process of playing an original segment in the target video, in response to a user clicking a switch control in the progress bar for playing the target video, send a third playback control signal to the video playback terminal; and

during the process of playing the highlight segment, in response to a user clicking the switch control, send a fourth playback control signal to the video playback terminal.

The video playback terminal is configured to, during the process of playing the original segment in the target video, play the highlight segment based on the received third playback control signal; and

during the process of playing the highlight segment, play the original segment based on the received fourth playback control signal.

In an exemplary implementation, the control terminal is configured to, in response to a user clicking a switch control in the progress bar for playing the target video, send a second jump control signal to the video playback terminal; and/or

in response to a user performing a click operation at a second position of the flight trajectory, send a third jump control signal to the video playback terminal.

The video playback terminal is configured to, based on the received second jump control signal, move the position mark in the flight trajectory map to the position corresponding to the current playback position of the target video; and/or

based on the received third jump control signal, switch the current playback position of the progress bar for playing the target video to the position corresponding to the second position.

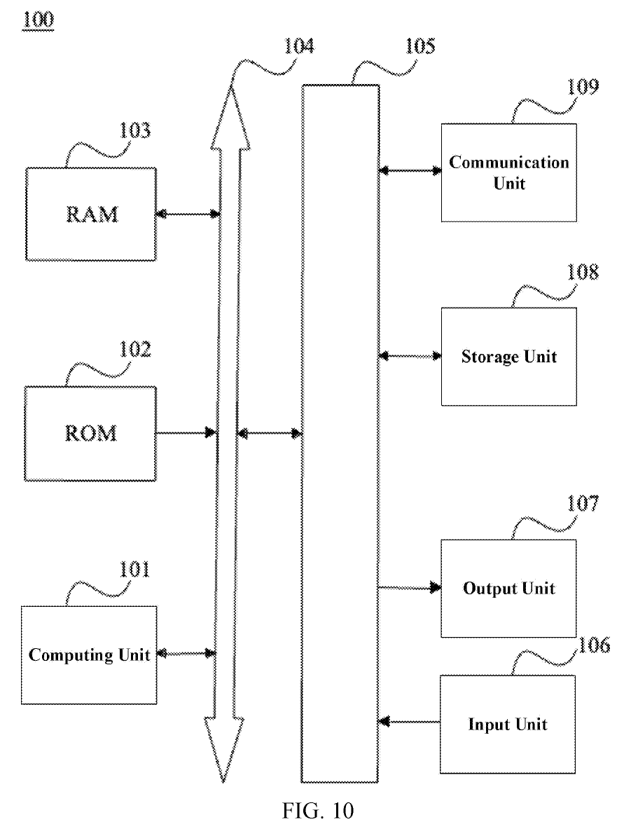

Referring to FIG. 10, the structural block diagram of a computer device that can serve as the video playback terminal of the present disclosure will now be described. The computer device includes a computing unit 101, which can perform various appropriate actions and processing according to a computer program stored in ROM 102 or a computer program loaded from storage unit 108 into RAM 103. Various programs and data required for the operation of computer device 100 can also be stored in RAM 103. The computing unit 101, ROM 102, and RAM 103 are connected to each other via a bus 104. An input/output (I/O) interface 105 is also connected to the bus 104.

Multiple components in computer device 100 are connected to the I/O interface 105, including: input unit 106, output unit 107, storage unit 108, and communication unit 109. The input unit 106 can be any type of device capable of inputting information to computer device 100, can receive input digital or character information, and generate key signal input related to user settings and/or function control of computer device 100, and can include but is not limited to a mouse, keyboard, touchscreen, trackpad, trackball, joystick, microphone, and/or remote control. The output unit 107 can be any type of device capable of presenting information, and can include but is not limited to a display, speaker, video/audio output terminal, vibrator, and/or printer. The storage unit 108 can include, but is not limited to, a magnetic disk, optical disk. The communication unit 109 allows computer device 100 to exchange information/data with other devices via a computer network such as the Internet and/or various telecommunications networks, and can include but is not limited to a modem, network card, infrared communication device, wireless communication transceiver and/or chipset, such as Bluetooth™ device, WiFi device, WiMax device, cellular communication device, and/or the like.

The computing unit 101 can be various general-purpose and/or special-purpose processing components with processing and computing capabilities. Some examples of the computing unit 101 include but are not limited to a central processing unit (CPU), graphics processing unit (GPU), various dedicated artificial intelligence (AI) computing chips, various computing units running machine learning model algorithms, digital signal processors (DSP), and any suitable processor, controller, microcontroller, etc. The computing unit 101 executes the various methods and processing described above, such as the video playback method. For example, in some implementations, the video playback method can be implemented as a computer software program, which is tangibly contained in a machine-readable medium, such as storage unit 108. In some implementations, part or all of the computer program can be loaded and/or installed onto computer device 100 via ROM 102 and/or communication unit 109. When the computer program is loaded into RAM 103 and executed by the computing unit 101, one or more operations of the video playback method described above can be performed. Alternatively, in other implementations, the computing unit 101 can be configured to perform the video playback method in any other suitable way (for example, by means of firmware).

The computer device 100 can be implemented by one or more application-specific integrated circuits (ASIC), digital signal processors (DSP), digital signal processing devices (DSPD), programmable logic devices (PLD), field programmable gate arrays (FPGA), controllers, microcontrollers, microprocessors, or other electronic components, for performing the above video playback method.

Those skilled in the art, after considering the specification and practicing the disclosure disclosed herein, will readily think of other implementations of the present disclosure. The present disclosure is intended to cover any variations, uses, or adaptations of the disclosure, which follow the general principles of the disclosure and include well-known or conventional techniques in the art not disclosed herein. The specification and implementations are to be regarded as exemplary only, and the true scope and spirit of the disclosure are indicated by the claims.

It should be understood that the present disclosure is not limited to the precise structure already described and shown in the drawings, and various modifications and changes can be made without departing from its scope. The scope of the present disclosure is limited only by the appended claims.

### Industrial Applicability

In the video playback method, video playback terminal, control terminal, and video playback system provided in the implementations of the present disclosure, during the playback of a target video shot by an aircraft, a flight trajectory map is displayed on the video playback screen to show the shooting position of the target video. The first highlight mark is displayed in the flight trajectory of the flight trajectory map, and the first highlight mark is configured to locate one or more highlight segments in the target video, so that the user can locate the highlight segment to be watched through the flight trajectory and the first highlight mark. Since the user can locate the highlight segment through the first highlight mark in the flight trajectory map during the process of playing the target video, the efficiency of locating highlight segments is improved. At the same time, since the flight trajectory corresponds to the shooting position of the target video, the flight trajectory can also be configured as a progress bar for playing the target video, thereby reducing the complexity of video positioning.

What is claimed is:

1. A video playback method, implemented on a video playback terminal, the video playback method comprising:
displaying a flight trajectory map on a video playback screen during a playback process of a target video,
wherein the flight trajectory map comprises a flight trajectory, and the flight trajectory comprises at least one first highlight mark configured to locate one or more highlight segments in the target video.

2. The video playback method according to claim 1, wherein:
the flight trajectory map is displayed in a small window on the video playback screen.

3. The video playback method according to claim 1, wherein:
the flight trajectory is associated with a playback progress of the target video, and a position mark in the flight trajectory is configured to locate a current playback position of the target video.

4. The video playback method according to claim 3, wherein the position mark comprises at least one of:
a framing direction mark, a direction of the framing direction mark being a framing direction corresponding to a picture of the target video being played; or
a movement direction mark, a direction of the movement direction mark being a flight direction in the flight trajectory map.

5. The video playback method according to claim 1, wherein after displaying the flight trajectory map on the video playback screen, the video playback method further comprises:
in response to a preview operation being performed at a first position of the flight trajectory, displaying a target preview screen corresponding to the first position or a target preview video within a preset time from the first position on the flight trajectory map.

6. The video playback method according to claim 5, wherein:
the video playback terminal comprises a head-mounted display device, the preview operation comprises a ray emission operation by a controller of an aircraft or an eye movement operation; or
the video playback terminal comprises a mobile phone or a camera, and the preview operation comprises a long-press operation.

7. The video playback method according to claim 1, wherein after displaying the flight trajectory map on the video playback screen, the video playback method further comprises:
in response to a click operation being performed at a second position of the flight trajectory, switching a picture of a target video playback to a picture corresponding to the second position.

8. The video playback method according to claim 1, wherein after displaying the flight trajectory map on the video playback screen, the video playback method further comprises:
in response to a click operation being performed on the at least one first highlight mark, playing a highlight segment corresponding to the first highlight mark as clicked, wherein a direction of a framing direction mark of a position mark in the flight trajectory map is a framing direction corresponding to a picture of the highlight segment being played.

9. The video playback method according to claim 1, wherein after displaying a progress bar for playing the target video on the video playback screen, the video playback method further comprises:
during a process of playing an original segment in the target video, in response to a switch control being performed in the progress bar for playing the target video, playing the one or more highlight segments; and
during a process of playing the one or more highlight segments, in response to the switch control, playing the original segment.

10. The video playback method according to claim 9, wherein a number of the one or more highlight segments is multiple; and
wherein playing the one or more highlight segments comprises:
playing a first highlight segment after a current playback position of the original segment; and/or
wherein playing the original segment comprises:
playing the original segment that is same as a picture of the first highlight segment.

11. The video playback method according to claim 1, wherein before displaying the flight trajectory map on the video playback screen, the video playback method further comprises:
obtaining the target video sent by an aircraft;
obtaining the one or more highlight segments by one of:
identifying the one or more highlight segments of the target video based on a preset algorithm for identifying at least one of a shooting subject or camera movement to obtain an identification result, and marking the one or more highlight segments in the target video based on the identification result; or
obtaining the one or more highlight segments in response to a highlight marking operation being performed on a segment in the target video.

12. A video playback terminal, wherein the video playback terminal comprises a memory and a processor, the memory is configured to store program instructions, and when the program instructions are executed by the processor, the processor is configured to:
display a flight trajectory map on a video playback screen during a playback process of a target video,
wherein the flight trajectory map comprises a flight trajectory, the flight trajectory comprises at least one first highlight mark configured to locate one or more highlight segments in the target video.

13. The video playback terminal according to claim 12, wherein:
the flight trajectory map is displayed in a small window on the video playback screen.

14. The video playback terminal according to claim 12, wherein:
the flight trajectory is associated with a playback progress of the target video, and a position mark in the flight trajectory is configured to locate a current playback position of the target video.

15. The video playback terminal according to claim 12, wherein:
a number of the at least one first highlight mark corresponding to each highlight segment is one, and the at least one first highlight mark is configured to indicate a start time of the corresponding highlight segment; or
a number of the at least one first highlight mark corresponding to each highlight segment is two, and the two first highlight marks are configured to indicate a start time and an end time of the corresponding highlight segment, respectively.

16. The video playback terminal according to claim 12, wherein:
the one or more highlight segments comprise a plurality of highlight segments; and
different ones of the plurality of highlight segments respectively correspond to different colors, different shapes, or both of the at least one first highlight mark.

17. The video playback terminal according to claim 12, wherein when the program instructions are executed by the processor, the processor is configured to:
in response to a preview operation being performed at a first position of the flight trajectory, display a target preview screen corresponding to the first position or a target preview video within a preset time from the first position on the flight trajectory map.

18. The video playback terminal according to claim 12, wherein when the program instructions are executed, the processor is configured to:
in response to a click operation being performed at a second position of the flight trajectory, switch a picture of a target video playback to a picture corresponding to the second position; and
in response to a click operation being performed on the at least one first highlight mark, play a highlight segment corresponding to the first highlight mark as clicked, wherein a direction of a framing direction mark of the position mark in the flight trajectory map is a framing direction corresponding to a picture of the highlight segment being played.

19. The video playback terminal according to claim 12, wherein when the program instructions are executed, the processor is configured to:
obtain the target video sent by an aircraft;
obtain the highlight segment by one of:
identifying the one or more highlight segments of the target video based on a preset algorithm for identifying at least one of a shooting subject or camera movement to obtain an identification result, and mark the one or more highlight segments in the target video based on the identification result; or
obtaining the one or more highlight segments in response to a highlight marking operation being performed on a segment in the target video.

20. A video playback system, wherein the video playback system comprises a video playback terminal and a control terminal, and the control terminal is connected to the video playback terminal;
the control terminal is configured to send a first playback control signal to the video playback terminal in response to a playback operation; and
the video playback terminal is configured to play a target video based on the first playback control signal as received, and display a flight trajectory map on a video playback screen,
wherein the flight trajectory map comprises a flight trajectory, the flight trajectory comprises a first highlight mark, and the first highlight mark is configured to locate one or more highlight segments in the target video.
